(19) United States
(12) Patent Application Publication
(10) Pub. No.: US 2002/0169769 A1
(43) Pub. Date: Nov. 14, 2002

(54) System and method of using manually triggered memory cues for delayed journal entry

(75) Inventor: Jared Joseph Jackson, Los Gatos, CA (US)

Correspondence Address: Samuel A. Kassatly, 6819 Trinidad Drive, San Jose, CA, 95120, US

(73) Assignee: International Business Machines Corporation

(21) Appl. No.: 09/854,324

(22) Filed: May 12, 2001

(51) Int. Cl. G06F 7/00

(52) U.S. Cl. 707/4

(57) ABSTRACT

A journal system and associated method allow a user or a group of users to request and retrieve a memory cue for preparing a delayed journal entry. Information is continually received from a person or a group of persons, at their own request, via wireless communication devices and sent to the journal system. At the user's request, the journal system combines information from external resources devices and information stored internally and generates a memory cue. The memory cue is stored for future access and generation of a delayed journal entry.

### FIELD OF THE INVENTION

The present invention relates to the field of data processing, and particularly to a software system and associated method for the dynamic creation of content-rich documents using manually triggered memory cues for delayed journal entry. More specifically, the system of the present invention allows a person or a group of users to generate manually triggered memory cues for delayed journal entry without loss of information.

### BACKGROUND OF THE INVENTION

In a complex technological society there is an ever increasing need to archive and retrieve data items such as computer files or data records. The portability of computer systems, such as laptops, has widened the range of geographical locations in which data items can be created and archived.

In addition, many users desire to keep some sort of formal account of their personal or professional activities. Since events that are worth recording occur less often while the user is seated behind a desk making entries in a journal or diary, noteworthy and meaningful events that occur “on the field” might not get recorded properly. Even for users who are faithful record keepers, details of past events are often forgotten by the time those events are finally recorded in a journal or diary.

To further complicate the data archiving and retrieval process, the rise of pervasive computing and wireless electronic communication has increased dramatically the amount of information available electronically. Information about the user, such as location, time, proximity of associates, events, and so forth have always been the crux of information recorded in a journal or diary. However, many individuals find it difficult to maintain the detail level of journaling they desire for personal and professional purposes.

This difficulty often arises because of the very nature of the events people perceive to be meaningful. Participants are often completely involved in the activities taking place, and do not have the time to make immediate record of the event details. For example, in a business setting, sales men and women involved in making sale presentations, might not dedicate the time to keep accurate records of potential customers they encounter and the meeting places. As another example, an individual at a social gathering will find it difficult to remember all the new acquaintances made and the discussion subjects of interest.

This problem is further exasperated by the advent and wide spread integration of diverse computing and communication devices such as mobile phones, wirelessly connected laptops, PDAs and GPS systems. These devices have expanded the need for a system capable of receiving continual information from a user or a group of users (collectively referred to herein as “users”), and that record the users' information and make it available to these users at some desired time in the future, for the purpose of helping these users reconstruct the details of past events.

There is therefore a need for a system and associated method that allow the users to access information received by different communication devices such as PDAs, GPS devices, and so forth. At the request of the users, the stored information would be reconstructed in a journal or diary. Such need has heretofore remained unsatisfied.

### SUMMARY OF THE INVENTION

The present invention provides a system and associated method that utilizes the emerging technologies of pervasive computing devices and wireless communication to allow users to expeditiously and easily delay the recording of an event, without losing detailed information about that event. The journal system and method reconstruct the details of past events and create delayed journal entries that can be accessed and/or expanded by the user at a later time.

According to one embodiment of the present invention, information is continually sent to the system by various users, by means of processors or wireless electronic devices such as mobile phones, wirelessly connected laptops, pagers, personal digital assistants (PDAs), GPS devices, or other similar devices. The information from individual users could be dispersed, that is it could be generated at different times and from different locations.

Users wishing to record events in their journals can, for example, press a dedicated button on a communication device and send the information to a remote computer system. The remote computer system receives and records all the information from the users, such as the users' geographical locations, the dates and times of the transmitted events, the activities in which the users are engaged, and any other information, fact, or metadata that is otherwise related to the users at the time the events occur. Once the information recording is completed, the users can, at their own leisure, request the recorded information and reconstruct the events in personalized journals or diaries, with the detailed facts being made readily accessible from the remote computer system. According to alternative embodiment, the remote computer system may prompt the users to complete the journal entries or “todo” tasks.

According to other embodiments of the present invention, the users do not communicate immediately with the remote or central computer system upon the occurrence of the events. As an example, users without immediate access to a transmission device (i.e., a PDA) that is capable of communicating with the remote computer system, may instead request the remote computer system to retrieve all the information about them and anything in their proximity at some specified time in the past.

In another embodiment, the remote computer system creates a “todo” event or similar invasive mechanism for the user who requests a delayed journal entry memory cue. Thus, the next time this user tries to access the remote computer system, the remote computer system may remind the user of an incomplete event in the user's journal and provide the user with the opportunity to complete the entry details. At the same time, information concerning the users, namely, calendar events, to do tasks, interests, profiles and other data are pre-stored the system.

When a particular user requests the generation of a journal entry memory cue, the remote computer system merges the various data it has accumulated from one or more external sources with the data stored internally in the remote computer system, and passes the merged information to a filtering mechanism that retrieves only that information which is relevant to this user and for the requested time period. The filtered information is then passed to a memory cue generator that collects the data and that creates a memory cue for delayed journal entry. The cued information is stored in a way that is readily accessible to this user when this user accesses the remote computer system to create a delayed journal entry.

As an illustration, a salesman who meets several prospective customers at various locations, now possesses a tool that allows him to postpone the formal recording of an event, without losing detailed information about that event. All he needs to do for example, is simply to press a button on his cellular phone, pager, PDA or any similar wireless communication device, which will send extrinsic information to a remote computer system which will record this information. Exemplary extrinsic information include, without limitation, calendar event data, time, date, name of event, names of other participants, companies or parties involved, persons present at the same location or in proximity thereof; and/or any other similar information.

At a later time, when this salesman wishes to make a delayed journal entry, he sends a request signal to the remote computer system via any available communication method, to generate a memory cue. The remote computer system will then combine all the information that it has collected from the external sources (for example if the salesman used many entry devices) with internally stored information available on the remote computer system. The merged information is then passed through a filter mechanism that is specific to this particular salesman and for the requested time period. The remote computer system then transmits the filtered information to a memory cue generator, which, in turn, generates a memory cue for the delayed journal entry. The salesman can then access the cued information at his convenience, and reconstruct the meetings with the prospective customers in his journal, without losing significant details.

An apparent benefit of the present invention is therefore the preservation of information which is becoming an increasingly valuable commodity. In addition, the system of the present invention better preserves past information that could be of great value to businesses, governments, and individuals. The system of the present invention also aids users so that entries can be both individualized and accurate.

### BRIEF DESCRIPTION OF THE DRAWINGS

The various features of the present invention and the manner of attaining them will be described in greater detail with reference to the following description, claims and drawings, and wherein:

FIG. 1 is a schematic illustration of an exemplary operating environment in which a journal system for generating memory cues for delayed journal entry according to the present invention can be used;

FIG. 2 is a block diagram of a high level architecture showing the journal system of FIG. 1 shown querying a Personal Inventory Management System (PIMS) and a Location Monitoring System (LMS) according to the present invention;

FIG. 3 is a block diagram of the journal system of FIG. 2, illustrating the main components of the journal system used to create journal cues or entries;

FIG. 4 is a block diagram of the journal system of FIGS. 2 and 3, illustrating the main components of the journal system used to retrieve and/or expand the journal entries created using the components of FIG. 3;

FIG. 5 is a flow chart representing an overall method of creating journal cues according to the present invention; and

FIG. 6 is a flow chart representing an overall method of retrieving and/or expanding the journal entries that were created by the method of FIG. 5.

### DETAILED DESCRIPTION OF THE PREFERRED EMBODIMENTS

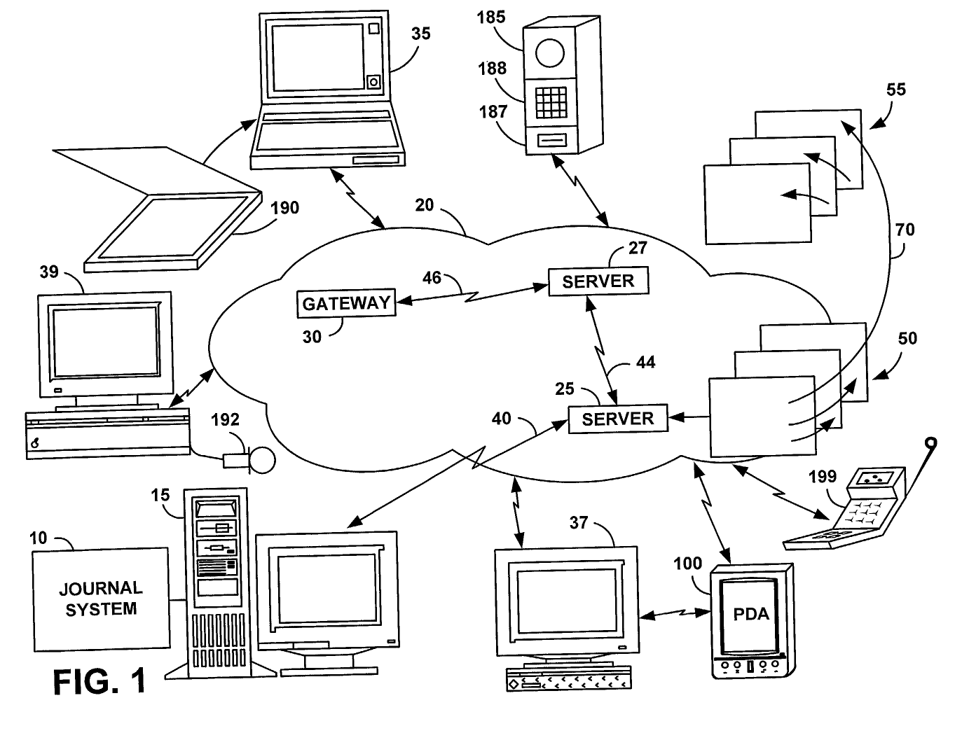

FIG. 1 portrays the overall environment in which a journal system 10 which is manually triggered for generating memory cues for delayed journal entries may be used in accordance with the present invention. Although an exemplary preferred embodiment of the system 10 will be described herein in connection with the WWW, it should be clear that the system 10 can be used with a stand-alone database of terms that may have been derived from the WWW and/or other sources.

In the exemplary illustration shown in FIG. 1, the system 10 is embedded within, or installed on a host server 15. Alternatively, the system 10 can be saved on a suitable storage medium such as a diskette, a CD, a hard drive, or like devices.

The WWW is represented as a cloud-like communication network 20 and is comprised of communication lines and switches connecting servers such as servers 25, 27, to gateways such as gateway 30. The servers 25, 27 and the gateway 30 provide the communication access to the server 15. For illustration purposes only, and without intent to limit the scope of the invention, the users are represented by a variety of computers such as computers 35, 37, 39, and a variety of other interface devices and appliances.

The host server 15 is connected to the network 20 via a communications link such as a telephone, cable, satellite link, or cellular radio network 40. The servers 25, 27 can be connected via high speed Internet network lines 44, 46 to other computers and gateways. The servers 25, 27 provide access to stored information such as hypertext or web documents indicated generally at 50, 55. The hypertext documents 50, 55 most likely include embedded hypertext links to other locally stored pages, and hypertext links 70 to other webs sites or documents 55 that are stored by various repositories or web servers such as the server 27.

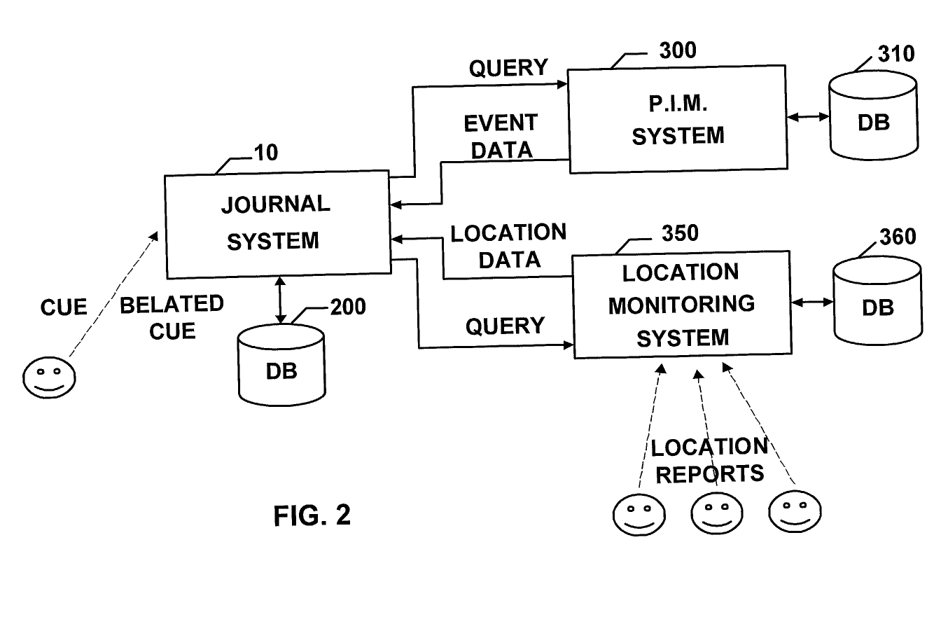

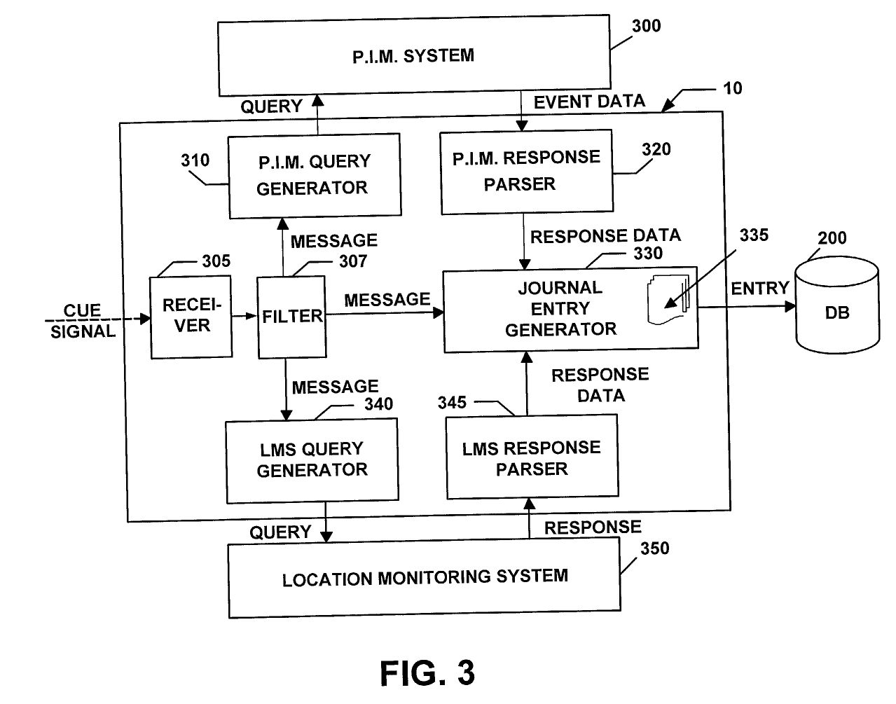

FIG. 2 depicts an exemplary system 10 connected to a personal inventory management system (PIMS) 300 and a location monitoring system (LMS) 350 according to the present invention. In operation, and as it will be explained later in greater detail in connection with FIGS. 3 through 6, a user wishing to record an event or event data in a journal entry or file, can press a dedicated button (or activate an application) using any one or more of the accessories or interfaces that are available to this user.

As an example, the user can employ a laptop computer 35, a desktop computer 39, a mobile phone/pager 74, a personal digital assistant (PDA), or any other communication device capable of generating and transmitting a cue, a prompt, or any other similar signal (collectively referred to herein as the “cue”) to the journal system 10. The journal system 10 is prompted by the cue to gather information from an internal database 200, such as the user's access authorization level and preferences that have been preset by the user and stored in the database 200. The journal system 10 saves the cue in the database 200 for later retrieval.

The journal system 10 also uses the user's identification (ID) to query the personal inventory management system 300 for the event or calendar information, including event time span, event location, event description, and event duration. This event information is typically stored in a database 310.

The journal system 10 can also use the cue and/or the user's identification (ID) to query the location monitoring system 350 for the location information (or location reporting) including the user's current location, and the current locations of other participants in the user's neighborhood. This information is typically stored in a database 360. In a preferred embodiment, the location monitoring system 350 continuously receives the location data from the data and the neighboring participants during the event.

The resulting event and location information (or data) is fed back to the journal system 10 that stores this information in the database 200 as a memory cue. The journal system 10 provides the user with the ability to request, review, and expand the memory cue entry. The expanded information can then be recorded as a formal entry in a journal or diary, which is referred to herein as “delayed journal entry”.

According to an alternative embodiment, in order to facilitate the creation of data entries from the response data from the personal inventory management system 300 and the location monitoring system 350, the journal entry generator 330 could use PIMS and LMS templates 335, respectively. As an illustration, a simple exemplary template 335 could be defined as follows:

Entry Date: <DATE>

User Location: <LOCATION>

Scheduled Events: <EVENTS>

. . . etc.

The journal entry generator 330 fills out the template 335 as a form using the PIMS and LMS response data as well as relevant data stored in the database 200. The form could be formatted as follows:

Entry Date: Apr. 4, 2001 10:30:00AM

User Location: Lat:37N Long:121W

Scheduled Events: _none_{—}

. . . etc.

According to yet another alternative embodiment, the present invention presents a method for generating memory cues for journal entry after the incident has occurred. For instance, a user is attending a gathering and wishes to create a journal entry about that gathering. However, the user either does not have an interface device available; was not able to generate or transmit the memory cue signal to journal system; or forgot to trigger the interface device to send the memory cue signal. Several hours or days later, the user wishes the system to retrieve the same or similar memory cues that would have been generated had the user initiates a cue signal at the time of the gathering. As long as the PIMS and LMS databases 310, 360, respectively have not deleted the data since the occurrence of the event (i.e., the gathering), it would still be possible to have a dynamically generated journal entry prepared and presented to the user. To this end, the user sends a belated cue signal to the journal system as described earlier, with the exception that in this belated cue signal is time stamped with the earlier date and time of the desired event. The time stamping can be entered manually by the user. The queries to the PIMS 300 and the LMS 350 will incorporate this timestamp instead of the current time. The journal system 10 will process the belated cue signal as described earlier, and will create and retrieve the memory cues corresponding to the belated cue signal.

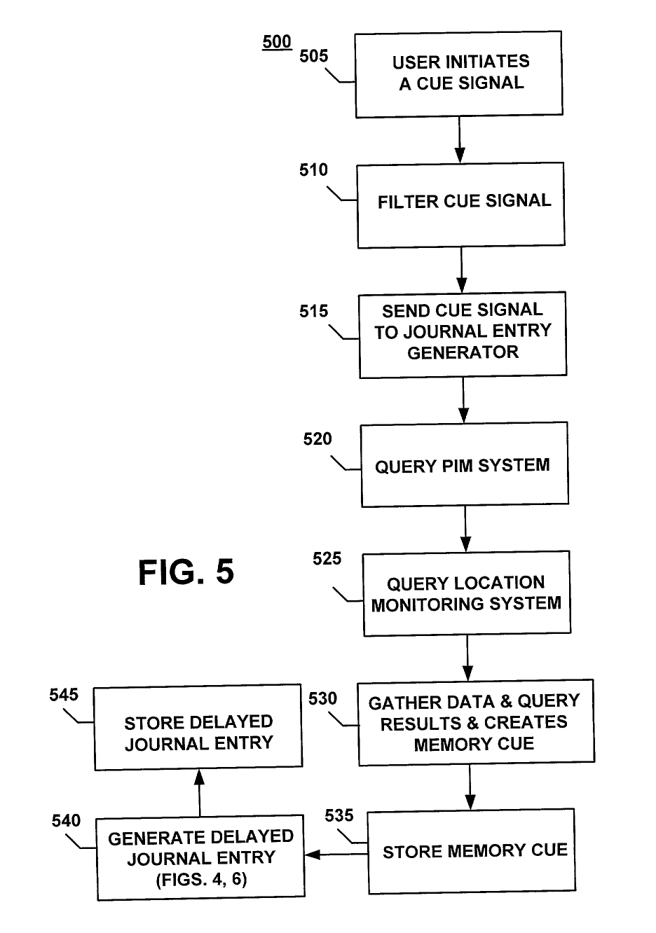

Having generally described the general environment in which the journal system 10 operates, its main components and its use will now be described in more detail in connection with FIGS. 3 through 6. The main components of the journal system 10 and a corresponding method 500 for creating a delayed journal entry will now be described in connection with FIGS. 3 and 5. With reference to FIG. 3, the journal system 10 generally includes a network receiver 305 that continuously monitors a network port for requests from the users.

When an event of particular importance to an individual user (or to multiple users) of the journal system 10 occurs, the user sends a signal to the journal system 10 requesting the generation of a memory cue. The user can use any or more available interface devices, such as those illustrated in FIG. 1. The interface device sends a request for a memory cue along with the user's ID to the network receiver 305. The step of initiating a cue signal is referenced by the numeral 505 in FIG. 5.

Upon receipt of the user's cue signal, and once the user's access is authenticated and authorized, the journal system 10 instructs a filter 307 at step 510, to retrieve only the information that is relevant to the requesting user for a designated time period or event.

The filter 307 sends the filtered request to a journal entry generator 330, at step 515. Optionally, the filter 307 also sends the filtered user's request as a query to a personal inventory management (PIM) query generator 310, at step 520, and/or to a location monitoring query generator 340, at step 525.

The PIM query generator 310 formulates a query and sends it to the personal inventory management system 300 for processing. The personal inventory management system 300 stores data about users, places, resources, calendar events, todos, interests, profiles, and other resources and information is stored about the users of the journal system 10.

The query result, including the event data, is transmitted from the personal inventory management system 300 to a personal inventory management (PIM) response parser 320 that parses the event data into appropriately formatted response data. The response data is sent to the journal entry generator 330 that generates the final memory cue.

The location monitoring system query generator 340 formulates a query and sends it to the location monitoring system 350 for processing. The query result, including the location data, is transmitted from the location monitoring system 350 to a location monitoring system response parser 345 that parses the location data into appropriately formatted response data. The response data is sent to the journal entry generator 330, which, as described herein, generates the final memory cue.

The role of the journal entry generator 330 is to collect the data from the user's cue, to retrieve relevant data stored in the database 200, to gather the query results from the personal inventory management system 300 and the location monitoring system 350, and to create a memory cue (step 530). The journal entry generator 330 stores the collected data in the database 200 for later retrieval by an authorized user (step 535). Optionally, the journal entry generator 330 may also invoke methods to remind the user of his of her request (or todo tasks) when the user eventually accesses the journal system 10.

At step 540 of FIG. 5, the user accesses the memory cue and creates a delayed journal entry therefrom, at step 540. The journal system 10 stores the delayed journal entry at 545 in database 200.

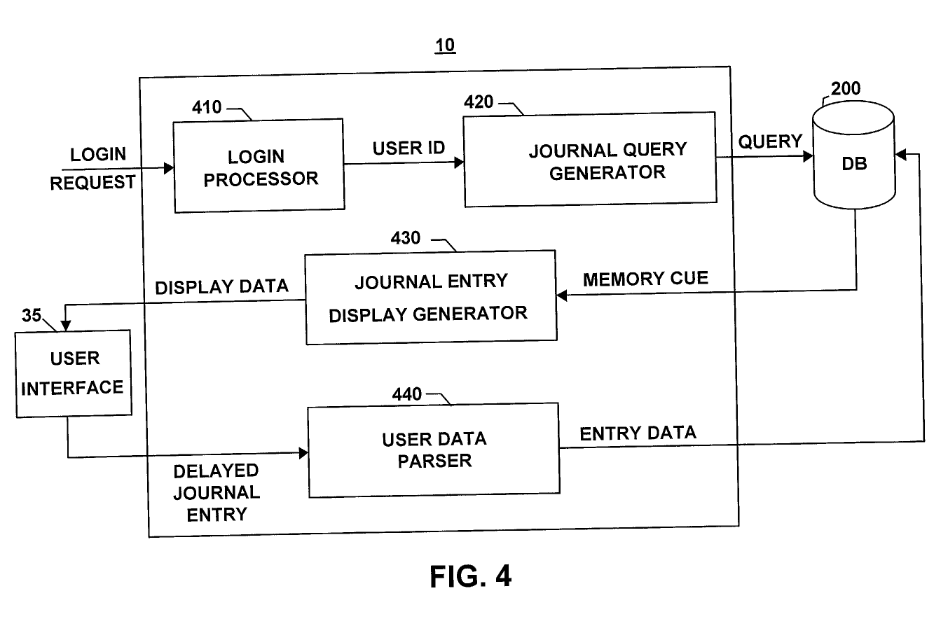

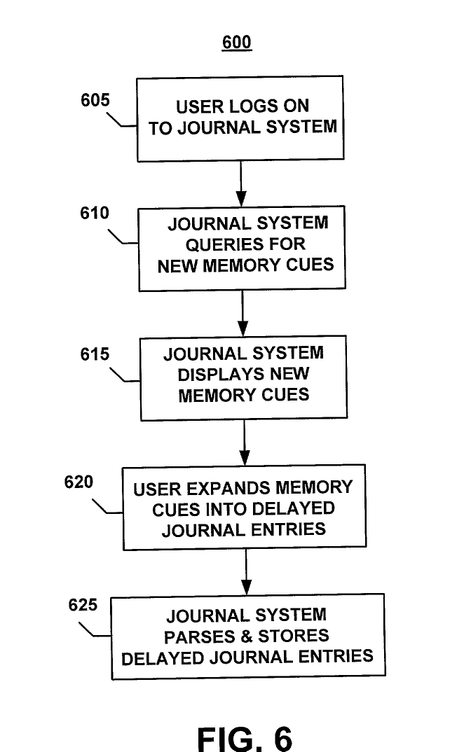

The main components of the journal system 10 and a corresponding method 600 for retrieving and expanding creating a delayed journal entry will now be described in connection with FIGS. 4 and 6. With reference to FIG. 4, the journal system 10 generally includes a login processor 410 that continuously monitors the network port for login requests from the users.

With further reference to FIG. 6, when the user logs on to the journal system 10, at step 605, the login processor 410 authenticates and authorizes the user's access. The login processor 410 also sends the user's ID to a journal query generator 420 that generates a query at step 610, querying the database 200 for newly created memory cues that have not yet been viewed by this particular user.

The database 200 sends the requested memory cues to a journal entry display generator 430 that displays the memory cues on one or more selected user interface devices, such as a processor 35, at step 615.

Using the interface device 35 and/or any other suitable interface devices, the user expands or otherwise changes the memory cues by adding new data, new entries, and/or organizing the memory cues to create delayed journal entries, at step 620. At step 625 the user sends these delayed journal entries to a user data parser 440 that parses the delayed journal entries and creates entry data therefrom. The parser 440 then sends the entry data to the database 200 for storage.

It is to be understood that the specific embodiments of the present invention that have been described are merely illustrative of certain application of the principle of the present invention. Numerous modifications may be made to the journal system and associated method described herein without departing from the spirit and scope of the present invention.

What is claimed is:

1. A method of generating a memory cue for a delayed journal entry related to an event, comprising the steps of:
storing a user profile;
receiving a remote cue signal from a user, requesting the generation of the memory cue;
filtering information corresponding to the user and to the event;
creating the memory cue based on filtered information;
storing the memory cue for future access; and
accessing the memory cue and creating a journal entry based on the memory cue.

2. The method of claim 1, further including storing the delayed journal entry.

3. The method of claim 1, further including generating a cue signal.

4. The method of claim 3, wherein the step of generating a cue signal includes pressing a single function key on a user interface device.

5. The method of claim 1, wherein the step of filtering information corresponding to the user and to the event includes using a user identification (ID).

6. The method of claim 6, further including the step of querying a personal inventory management system for any one or more of event or calendar information.

7. The method of claim 6, wherein the step of querying the personal inventory management system includes querying for any one or more of the following information: event time span, event location, event description, event duration.

8. The method of claim 6, further including the step of querying a location monitoring system for location information.

9. The method of claim 8, further wherein the step of querying the location monitoring system includes querying for any one or more of the following information: user's current location, current locations of other participants in a desired event.

10. The method of claim 7, further including the step of querying a location monitoring system for location information.

11. The method of claim 10, further including the step of continuously monitoring event information and location information.

12. The method of claim 1, wherein the step of creating the memory cue includes using a predefined template.

13. The method of claim 1, wherein the step of receiving the cue signal includes creating a belated cue signal.

14. The method of claim 13, wherein the step of creating the belated cue signal includes time stamping the cue signal to generate a memory cue related to a past event.

15. A system for generating manually triggered memory cues for delayed journal entry, comprising:
a receiver for receiving a cue signal from a plurality of users;
a database for storing internal information about a plurality of users and places, and for further storing data received from external devices;
a filter for retrieving only information relevant to a particular user during a specified time period;
a journal entry generator for creating a memory cue and for storing the memory cue for future access; and
a journal memory cue generator for retrieving the memory cue and for creating a delayed journal entry based on the memory cue and additional information from a user.

16. The system of claim 15, wherein the delayed journal entry is stored in the database.

17. The system of claim 16, wherein the receiver includes a server.

18. The system of claim 17, further including a user interface device that generates the cue signal.

19. The system of claim 18, wherein the user interface device includes a single key that is dedicated to generate the cue signal.

20. The system of claim 18, wherein the user interface device includes an application that generates the cue signal.

21. The system of claim 1, wherein the filter uses a user identification (ID) to retrieve relevant information.

22. A software program product for generating a memory cue for a delayed journal entry related to an event, comprising the steps of:
means for storing a user profile;
means for receiving a remote cue signal from a user, requesting the generation of the memory cue;
means for filtering information corresponding to the user and to the event;
means for creating the memory cue based on filtered information;
means for storing the memory cue for future access; and
means for accessing the memory cue and creating a journal entry based on the memory cue.

23. The software program product of claim 22, further including means for storing the delayed journal entry.

24. The software program product of claim 22, further including means for generating a cue signal.

25. The software program product of claim 24, wherein the means for generating the cue signal includes a single function key on a user interface device.
